(19) United States
(12) Patent Application Publication
(10) Pub. No.: US 2005/0224061 A1
(43) Pub. Date: Oct. 13, 2005

(54) Oil-separating device

(76) Inventors: Markus Ulrich, Rudersberg (DE); Dietmar Uhlenbrock, Tecklenburg (DE)

Correspondence Address: Striker Striker & Stenby, 103 East Road, Huntington, NY, 11743, US

(21) Appl. No.: 10/362,640

(22) PCT Filed: Aug. 8, 2002
(86) PCT No.: PCT/DE02/02917

§ 371 Date: Feb. 25, 2003

(30) Foreign Application Priority Data
Jan. 29, 2002 (DE) 102 03 274.2

(51) Int. Cl. F02M 25/06

(52) U.S. Cl. 123/573; 96/188

(57) ABSTRACT

The invention relates to an oil separating device for separating out oil droplets conveyed in a crankcase gas flow released by a crankcase ventilation of an internal combustion engine, including at least one separating element, at least part of which the gas flow passes through.

The invention provides that the separating element (6) contains a granulate (22) comprised of a plastic. This measure achieves a high separation rate of smaller oil droplets.

### PRIOR ART

The invention is based on an oil separating device according to the preamble to claim 1, which is used to separate out oil droplets conveyed in a crankcase gas flow released by a crankcase ventilation of an internal combustion engine.

In internal combustion engines, the excess pressure in a crankcase is offset by means of a crankcase ventilation; the gas sucked out by this ventilation contains high concentrations of hydrocarbons and therefore cannot be simply released into the surrounding atmosphere. Instead, this so-called blowby gas is recycled back into the intake section of the engine in order to convey it to the combustion chamber. In addition to hydrocarbons, the blowby gas also contains an oil mist with oil droplets of different droplet sizes, in particular relatively small oil droplets. The latter in particular lead to erroneous measurements when the blowby gas is conveyed through a hot film air mass meter (HFM) contained in the intake section, which results in an undesirable deterioration of the emissions behavior of the engine.

For this reason, in the past, oil separators have been developed to separate out oil droplets conveyed in a crankcase gas flow released by a crankcase ventilation of an internal combustion engine. Oil separators of this kind contain an oil separating element, at least part of which the gas flow passes through and which is embodied, for example, in the form of cyclones, helixes, wire knits, yarns, and tiles. It is also known to use settling chambers for oil separation. DE 37 01 587 C1, which defines the species, has disclosed an oil separating device in which the oil separating element is comprised of a sleeve-shaped metal knit contained in a housing.

A common feature of the above-mentioned oil separating elements is that they are essentially capable of filtering out only larger oil droplets from the gas flow, for example settling chambers can filter out droplets larger than 4 μm, helixes and cyclones can filter out droplets larger than 3 μm, and wire knits can filter out droplets larger than 1 μm. Tile oil separators and electrostatic precipitators can in fact separate out smaller droplets, but tiles cause a high pressure loss between the inlet and the outlet, and electrostatic precipitators are relatively expensive.

### ADVANTAGES OF THE INVENTION

The plastic granulate contained in the oil separating element has a large separation surface area, which achieves a high separation rate, particularly with regard to extremely fine oil droplets. This behavior is particularly advantageous in self-igniting engines with relatively high blowby gas quantities and a correspondingly pronounced tendency of the hot film air mass meter to become soiled. At the same time, the gaps between the individual granulate particles leave open a sufficient flow cross section so that only a small pressure loss occurs in the gas flow between the inlet and outlet, and the oil separating element does not become clogged. Finally, plastic granulate is a very inexpensive material.

The steps taken in the dependent claims permit advantageous modifications and improvements of the invention disclosed in claim 1.

According to a particularly preferably embodiment, the granulate is densely packed and contains fibers, which protrude partially out from the granulate particles. The glass fibers increase the separation surface area in order to achieve an even higher separation rate.

According to a preferred modification, the granulate is comprised of a thermoplastic, for example polyamide, and contains cylindrical extrusion molded particles with a diameter of approximately 2.5 to 3.5 mm. Alternatively, the granulate can also be comprised of a ground material. As is known, ground particles have an irregular, heavily textured surface, which offers a large separation surface area. It is also advantageous that the granulate is obtained from an inexpensively reprocessed plastic material and the particle size can be adapted at will to the current constraints.

In a particularly preferable embodiment, the granulate is contained in a replaceable cartridge, which is inserted into a housing and whose walls—at least those on the inlet and outlet sides—are provided with flow openings for the gas flow. Then a cartridge of this kind can be easily replaced in the event of operating malfunctions or as a part of maintenance work.

### DRAWINGS

Exemplary embodiments of the invention are shown in the drawings and will be explained in detail in the subsequent description.

FIG. 1 shows a schematic cross section through a preferred embodiment of an oil separating device according to the invention,

FIG. 2 shows a second embodiment of the oil separating device according to the invention,

FIG. 3 shows a third embodiment of the oil separating device according to the invention.

### DESCRIPTION OF THE EXEMPLARY EMBODIMENTS

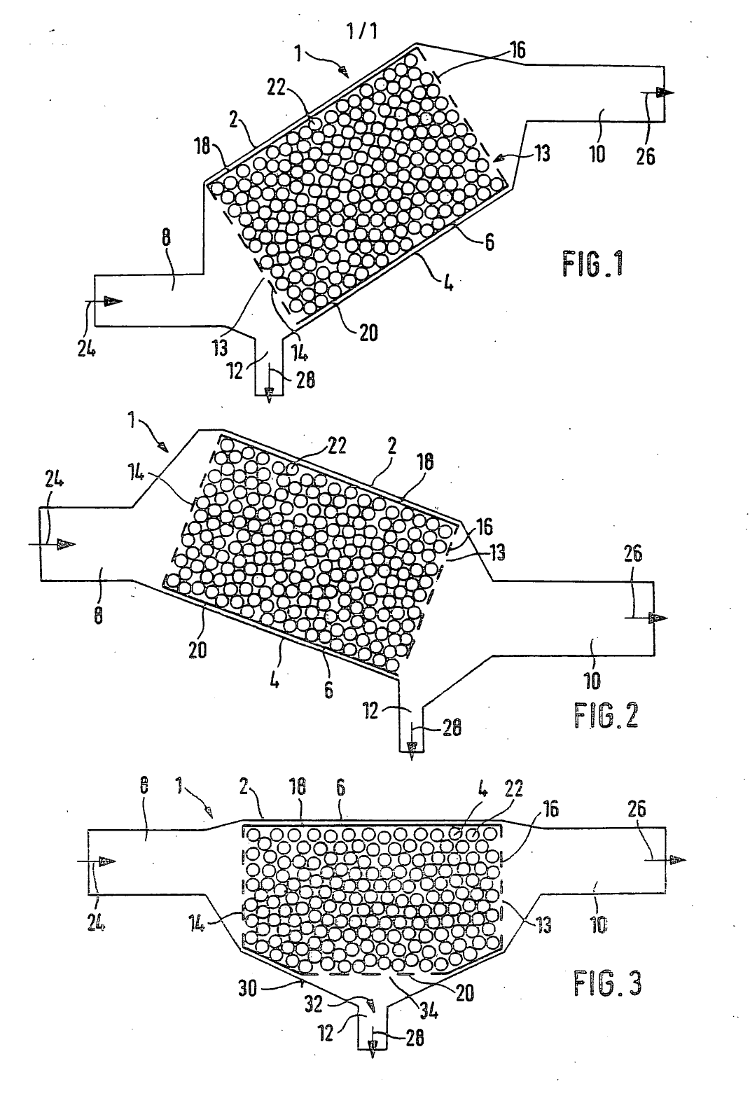

FIG. 1 shows a preferred exemplary embodiment of an oil separating device 1 according to the invention, in a schematic side view in the installed position, i.e. components that are shown at the bottom in the figure are also installed at the bottom.

The oil separating device 1 essentially includes a housing 2 and an oil separating element 6 contained in a cylindrical middle section 4 of the housing 2. This middle section of the housing 2 is embodied as a cylindrical sleeve 4, one end of which is connected to an inlet fitting 8 and the other end of which is connected to an outlet fitting 10 so that in terms of flow, the oil separating element 6 is interposed fluidically between the inlet fitting 8 and the outlet fitting 10. Vertically speaking, the outlet fitting 10 is disposed higher than the inlet fitting 8 so that the oil separating element 6 is held in the housing 2 in a position that is inclined upward in the flow direction.

The inlet fitting 8 is connected to the crankcase ventilation of an internal combustion engine and this connection supplies the oil separating device 1 with a gas flow containing dispersed oil droplets. The oil separating device 1 is designed to separate out oil droplets conveyed in the gas flow, particularly the fine oil droplets, into a preferably vertical oil return conduit 12, which is disposed upstream of the oil separating element 6 and is connected to the inlet fitting 8. The outlet fitting 10 is preferably connected to an intake conduit of the engine, which is not shown in the drawings for reasons of scale.

For example, the oil separating element contains a replaceable cartridge 6, which is inserted into the cylindrical middle section 4 of the housing 2 and is embodied, for example, in the form of a cylindrical sleeve whose end walls 14, 16 are provided with perforations 13 and are preferably comprised of perforated sheet metal, wire knit, or injection molded parts with perforated matrixes. By contrast, the circumference wall 18 of the cartridge 6 is unperforated, at least in a lower region 20, and is embodied as a flow path. The perforations 13 of the front end wall 14 of the cartridge 6, viewed in the flow direction, connect the oil return conduit 12 to the sloping circumference wall 18 and in particular, to the flow path 20 of the cartridge 6.

The cartridge 6 contains densely packed, preferably fiber-containing granulate 22 comprised of a plastic, the fibers protruding a certain distance out from the granulate particles 22. The granulate is preferably comprised of a thermoplastic, preferably polyamide, and contains cylindrical extrusion molded particles 22 with a diameter of approximately 2.5 to 3.5 mm. However, it is also conceivable for the particles 22 to be rectangular or otherwise shaped. Alternatively, the granulate 22 is comprised of a ground material, preferably with an irregular, heavily textured surface. It is particularly preferable if the granulate 22 is comprised of plastic material recovered from waste products. Clearly the perforations 13 of the cartridge 6 have an opening cross section that is smaller than the size of the granulate particles 22.

In view of these facts, the oil separating device 1 according to the invention functions as follows:

The blowby gas indicated by the arrow 24, which contains oil droplets of various dimensions and is supplied by the crankcase ventilation to the oil separating device 1 through the inlet fitting 8, travels through the perforated end wall 14 into the interior of the cartridge 6 and between the granulate particles 22 contained in it; due to fluid adhesion, the oil droplets first settle on the surface of the particles 22, while the gas, essentially freed of the oil, passes through the perforated rear end wall 16 of the cartridge 6 and travels through the outlet fitting 10 to the intake conduit, as indicated by the additional arrow 26. If the surfaces of the particles 22 become saturated with oil after a period of time and the force of gravity has exceeded the adhesion force, then the oil trapped in the cartridge flows along the adjacent particles in a downward direction due to the force of gravity and collects along the flow path 20 in the lower region of the circumference wall 18 of the cartridge 6 that is inclined toward the oil return conduit 12. Then it passes through the front perforated end wall 14 of the cartridge 6 and flows essentially counter to the flow direction of the gas, into the oil return conduit 12 situated in the immediate vicinity, from which it is conveyed to an oil reservoir, which is indicated by the arrow 28.

In the remaining exemplary embodiments of the invention according to FIGS. 2 and 3, parts that are the same or function in the same manner as in the preceding example are labeled with the same reference numerals. By contrast to the above-described exemplary embodiment, in the embodiment according to FIG. 2, the outlet fitting 10 is situated at a lower vertical position than the inlet fitting 8 so that the cartridge 6 is held in the housing 2 sloping downward in the flow direction of the gas flow. Correspondingly, the oil return conduit 12 is disposed after the cartridge 6 in the flow direction and the separated oil flows into this oil return conduit 12 after it has traveled in the flow direction and then along the flow path 20 of the sloping circumference wall 18.

As shown in FIG. 3, the cartridge 6 in the housing 2 can also be held in an essentially horizontal position. Then the inlet fitting 8 and the outlet fitting 10 are essentially situated at the same height. In this embodiment, the bottom of the middle section 4 of the housing 2 is embodied in the form of a funnel 30, the bottom of whose funnel opening 32 feeds into the oil return conduit 12. In order to permit separated oil to enter into the funnel 30, the lower circumference wall 18 of the cartridge 6 facing the funnel 30 is provided with at least one through opening 34, and is preferably perforated.

1. An oil separating device for separating out oil droplets conveyed in a crankcase gas flow released by a crankcase ventilation of an internal combustion engine, including at least one separating element, at least part of which the gas flow passes through, characterized in that the separating element (6) contains a granulate (22) comprised of a plastic.

2. The oil separating device according to claim 1, characterized in that the granulate (22) is densely packed and contains fibers, which protrude partially out from the granulate particles.

3. The oil separating device according to claim 2, characterized in that the fibers contain glass fibers.

4. The oil separating device according to claim 2 or 3, characterized in that the plastic contains at least one thermoplastic.

5. The oil separating device according to claim 4, characterized in that the plastic is comprised of polyamide.

6. The oil separating device according to one of the preceding claims, characterized in that the granulate (22) contains cylindrical extrusion molded particles with a diameter of approximately 2.5 to 3.5 mm.

7. The oil separating device according to one of claims 1 to 5, characterized in that the granulate (22) is a ground material and has a textured surface.

8. The oil separating device according to one of the preceding claims, characterized in that the granulate (22) is contained in a replaceable cartridge (6), which is inserted into a housing (2) and whose walls (14, 16)—at least those on the inlet and outlet side—are provided with flow openings (13) for the gas flow.

9. The oil separating device according to claim 8, characterized in that the cartridge (6) is embodied as a cylindrical sleeve with perforated end walls (14, 16).

10. The oil separating device according to claim 9, characterized in that the circumference wall (18) of the cartridge (6), at least in the lower region, is embodied as a flow path (20).

11. The oil separating device according to claim 10, characterized in that the cartridge (6) is held in the housing (2) so that it is inclined upward in the flow direction.

12. The oil separating device according to claim 11, characterized in that an oil return (12) fluidically connected to the circumference wall (18) is disposed upstream of the cartridge (6) in the flow direction.

13. The oil separating device according to claim 10, characterized in that the cartridge (6) is held in the housing (2) so that it is inclined downward in the flow direction.

14. The oil separating device according to claim 13, characterized in that an oil return (12) fluidically connected to the circumference wall (18) is disposed downstream of the cartridge (6) in the flow direction.

15. The oil separating device according to claim 9, characterized in that the cartridge (6) is held in an essentially horizontal position in the housing (2).

16. The oil separating device according to claim 15, characterized in that the lower region of the circumference wall (18) of the cartridge (6) is provided with at least one through opening (34), which is connected to an oil return (12).

17. An oil separating device for separating out oil droplets conveyed in a crankcase gas flow released by a crankcase ventilation of an internal combustion engine, including at least one separating element, at least part of which the gas flow passes through, characterized in that the separating element (6) contains a granulate (22) comprised of a plastic.

18. The oil separating device according to claim 17, characterized in that the granulate (22) is densely packed and contains fibers, which protrude partially out from the granulate particles.

19. The oil separating device according to claim 18, characterized in that the fibers contain glass fibers.

20. The oil separating device according to claim 18, characterized in that the plastic contains at least one thermoplastic.

21. The oil separating device according to claim 20, characterized in that the plastic is comprised of polyamide.

22. The oil separating device according to claim 17, characterized in that the granulate (22) contains cylindrical extrusion molded particles with a diameter of approximately 2.5 to 3.5 mm.

23. The oil separating device according to claim 17, characterized in that the granulate (22) is a ground material and has a textured surface.

24. The oil separating device according to claim 17, characterized in that the granulate (22) is contained in a replaceable cartridge (6), which is inserted into a housing (2) and whose walls (14, 16)—at least those on the inlet and outlet side—are provided with flow openings (13) for the gas flow.

25. The oil separating device according to claim 24, characterized in that the cartridge (6) is embodied as a cylindrical sleeve with perforated end walls (14, 16).

26. The oil separating device according to claim 25, characterized in that the circumference wall (18) of the cartridge (6), at least in the lower region, is embodied as a flow path (20).

27. The oil separating device according to claim 26, characterized in that the cartridge (6) is held in the housing (2) so that it is inclined upward in the flow direction.

28. The oil separating device according to claim 27, characterized in that an oil return (12) fluidically connected to the circumference wall (18) is disposed upstream of the cartridge (6) in the flow direction.

29. The oil separating device according to claim 26, characterized in that the cartridge (6) is held in the housing (2) so that it is inclined downward in the flow direction.

30. The oil separating device according to claim 29, characterized in that an oil return (12) fluidically connected to the circumference wall (18) is disposed downstream of the cartridge (6) in the flow direction.

31. The oil separating device according to claim 25, characterized in that the cartridge (6) is held in an essentially horizontal position in the housing (2).

32. The oil separating device according to claim 31, characterized in that the lower region of the circumference wall (18) of the cartridge (6) is provided with at least one through opening (34), which is connected to an oil return (12).
